(19) United States
(12) Patent Application Publication
(10) Pub. No.: US 2026/0051154 A1
(43) Pub. Date: Feb. 19, 2026

(54) INFORMATION PROCESSING DEVICE, INFORMATION PROCESSING METHOD, AND RECORDING MEDIUM

(71) Applicant: SONY SEMICONDUCTOR SOLUTIONS CORPORATION, KANAGAWA (JP)

(72) Inventors: Takuya NISHIMURA, KANAGAWA (JP); Yusuke FUJII, KANAGAWA (JP); Norihiro TANABE, KANAGAWA (JP); Hiroki YAMASHITA, KANAGAWA (JP)

(21) Appl. No.: 18/995,963

(22) PCT Filed: Jul. 20, 2023
(86) PCT No.: PCT/JP2023/026535

§ 371 Date: Jan. 17, 2025

(30) Foreign Application Priority Data
Aug. 2, 2022 (JP) 2022-123106

(51) Int. Cl. G06V 10/774; G06V 10/94

(52) U.S. Cl. CPC G06V 10/774; G06V 10/945

(57) ABSTRACT

The present technique relates to an information processing device, an information processing method, and a recording medium that easily acquire an image suitable for a use case of AI. The information processing device according to the present technique includes a selection unit that selects a learning image used for learning of a learning model, according to a use case of the learning model using an image as an input, from among an image group held in advance. The present technique is applicable, for example, to a data set generation device that generates a data set including a large number of learning images.

### TECHNICAL FIELD

The present technique relates to an information processing device, an information processing method, and a recording medium, and more particularly to an information processing device, an information processing method, and a recording medium that enable to easily acquire an image suitable for a use case of AI.

### BACKGROUND ART

In recent years, it is necessary to prepare a data set including a large number of images, for the purpose of use such as learning of artificial intelligence (AI). For example, PTL 1 describes a data management system that classifies raw data collected from a data source and generates a data set.

### CITATION LIST

### Patent Literature

### [PTL 1]

JP 2021-068181A

### SUMMARY

### Technical Problem

The data management system described in PTL 1 needs to collect a large number of images for AI learning, by a user oneself, by a method for imaging an actual scene, searching for an appropriate image from images published on the Internet, or using data sets published on Websites.

With these methods, there is a case where it takes effort to collect a large number of images or the collected image is not appropriate for the use case of the AI.

The present technique has been made in view of such a situation, and is configured to easily acquire an image suitable for a use case of the AI.

### Solution to Problem

An information processing device according to one aspect of the present technique includes a selection unit that selects a learning image used for learning of a learning model, according to a use case of the learning model using an image as an input, from among an image group held in advance.

An information processing method according to one aspect of the present technique includes selecting a learning image used for learning of a learning model, according to a use case of the learning model using an image as an input, from among an image group held in advance, by an information processing device.

A recording medium according to one aspect of the present technique records a program for executing processing for selecting a learning image used for learning of a learning model, according to a use case of the learning model using an image as an input, from among an image group held in advance.

In one aspect of the present technique, a learning image used for learning of a learning model is selected, according to a use case of the learning model using an image as an input, from among an image group held in advance.

### BRIEF DESCRIPTION OF DRAWINGS

FIG. 1 is a diagram illustrating a configuration example of an AI learning system according to an embodiment of the present technique.

FIG. 2 is a diagram describing a flow in which a data set generation device generates a data set.

FIG. 3 is a diagram illustrating an example of an input interface of each setting and an example of information input in each setting.

FIG. 4 is a diagram for describing details of the data set generation performed in step S5 in FIG. 2.

FIG. 5 is a diagram illustrating an example of a table used to select an image suitable for a use case.

FIG. 6 is a diagram describing a flow after the data set is generated.

FIG. 7 is a diagram illustrating an example of an output interface of display on a GUI and an example of displayed information.

FIG. 8 is a diagram illustrating a first display example of an input GUI.

FIG. 9 is a diagram illustrating a second display example of the input GUI.

FIG. 10 is a diagram illustrating a third display example of the input GUI.

FIG. 11 is a diagram illustrating a fourth display example of the input GUI.

FIG. 12 is a diagram illustrating a fifth display example of the input GUI.

FIG. 13 is a diagram illustrating a first display example of an output GUI.

FIG. 14 is a diagram illustrating a display example of a learning image list screen.

FIG. 15 is a diagram illustrating a second display example of the output GUI.

FIG. 16 is a display example illustrating a third display example of the output GUI.

FIG. 17 is a diagram illustrating a fourth display example of the output GUI.

FIG. 18 is a block diagram illustrating a configuration example of the data set generation device.

FIG. 19 is a diagram illustrating an example of camera simulation.

FIG. 20 is a diagram illustrating an example of an image output by an AI engine.

FIG. 21 is a flowchart for describing processing executed by the data set generation device.

FIG. 22 is a diagram illustrating another display example of the input GUI.

FIG. 23 is a block diagram illustrating a configuration example of hardware of a computer.

### DESCRIPTION OF EMBODIMENTS

An embodiment for implementing the present technique will be described below.

The description will be made in the following order.
1. Outline of AI Learning System
2. About GUI
3. Configuration and Behavior of Data Set Generation Device
4. Modification

### <1. Outline of AI Learning System>

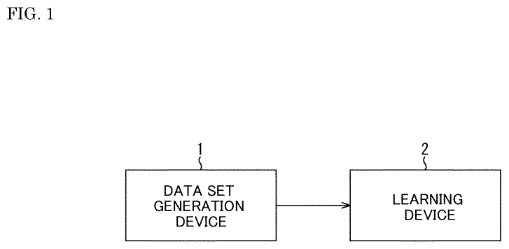

FIG. 1 is a diagram illustrating a configuration example of an AI learning system according to an embodiment of the present technique.

As illustrated in FIG. 1, the AI learning system includes a data set generation device 1 and a learning device 2.

The data set generation device 1 is an information processing device that displays a graphical user interface (GUI) used to input a use case of AI and generates a data set including a plurality of learning images according to the use case. The learning image is an image used for learning of the AI. The data set is generated by selecting the image suitable for the use case, as the learning image, from among an image group held by the data set generation device 1 in advance, for example.

In the data set generation device 1, an image generated using CG, an image captured in a live-action manner, and metadata corresponding to each image are registered in a database. The metadata corresponding to each image includes information indicating a type of a subject imaged in the image or a type of a background, a depth map corresponding to the image, a segmentation result for the image, or the like. The image registered in the database may include a still image or a moving image.

The data set generation device 1 supplies the generated data set to the learning device 2.

The learning device 2 performs learning using the data set supplied from the data set generation device 1 and generates an AI engine including AI (learning model). The learning device 2 may relearn the AI using the data set supplied from the data set generation device 1.

Note that the learning device 2 may have a configuration including the data set generation device 1. In this case, when a user inputs the use case using the GUI, the learning device 2 can generate the data set and learn the AI.

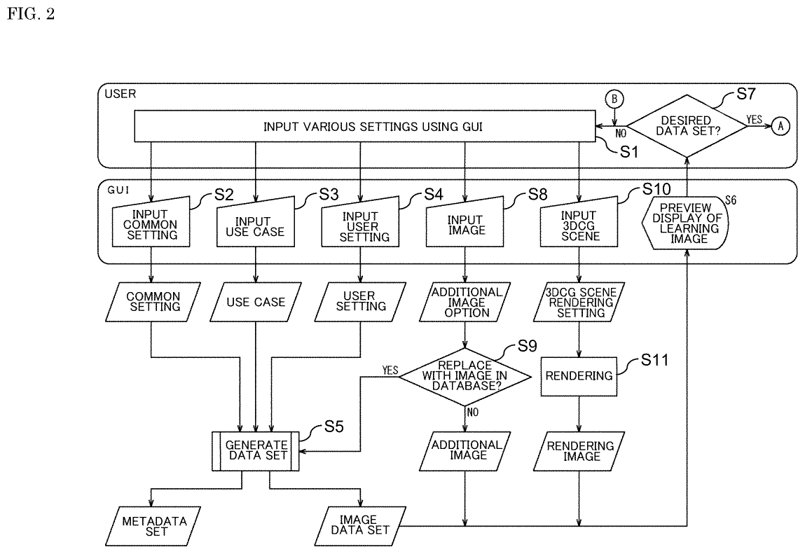

A flow in which the data set generation device 1 generates the data set will be described, with reference to FIG. 2.

In step S1, the user inputs various settings to generate the data set, using the GUI displayed on the data set generation device 1.

In steps S2 to S4, the data set generation device 1 receives inputs of common setting, a use case, and user setting via the GUI.

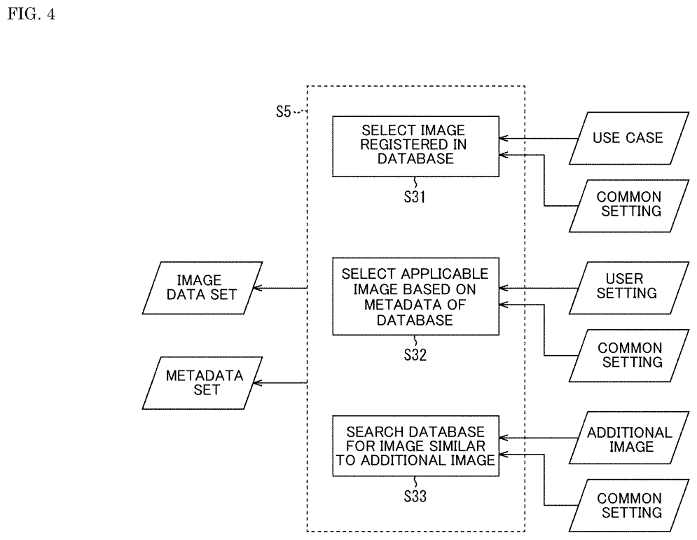

In step S5, the data set generation device 1 generates the data set. By generating the data set, an image according to the common setting, the use case, and the user setting input via the GUI is selected as a learning image from the image group registered in the database, and an image data set and a metadata set are generated. The image data set is a data set including the plurality of learning images, and the metadata set is a data set including metadata corresponding to each of the plurality of learning images. Details of the data set generation will be described later with reference to FIG. 4.

In step S6, the data set generation device 1 displays preview of the learning image on the GUI.

In step S7, the user views the preview display of the learning image on the GUI and determines whether or not the image data set generated by the data set generation device 1 is a desired data set.

In a case where it is determined in step S7 that the image data set is not the desired data set, the procedure returns to step S1, and the user further inputs or changes the setting using the GUI. For example, the user can input an additional image that is an image to be added to the image data set or input a 3DCG scene.

In step S8, the data set generation device 1 receives the input of the additional image via the GUI. Here, for example, an option indicating whether or not to replace the additional image with the image in the database is input together with the additional image.

In step S9, the data set generation device 1 determines whether or not to replace the additional image with the image in the database, based on the option.

In a case where it is determined in step S8 that the additional image is replaced with the image in the database, in the data set generation in step S5, the data set generation device 1 selects an image to be added to the image data set, from among the image group held in the database, based on the additional image. Specifically, the data set generation device 1 searches for an image similar to the additional image (similar image) from the image group held in the database and adds the similar image to the image data set.

On the other hand, in a case where it is determined in step S8 that the additional image is not replaced with the image in the database, the data set generation device 1 adds the additional image to the image data set as it is and displays the preview of the learning image in step S6.

In step S10, the data set generation device 1 receives an input of the 3DCG scene via the GUI. When the 3DCG scene is input, for example, a 3DCG scene file including a 3D model (CG model) of computer graphics (CG) and settings of rendering are input to the data set generation device 1. Here, the 3D model of the CG indicates a model of a three-dimensional object and a surrounding environment formed in a virtual space.

In step S11, the data set generation device 1 generates a rendering image by performing rendering using the 3DCG scene file and adds the rendering image to the image data set. Thereafter, in step S6, the data set generation device 1 displays the preview of the learning image.

Note that the user can input the common setting, the use case, the user setting, the additional image, and the 3DCG scene in any order.

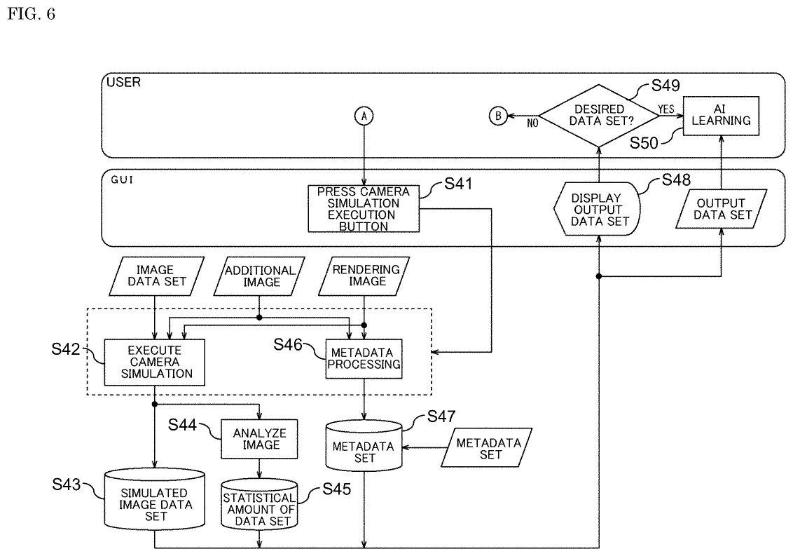

In a case where the user views the preview display of the learning image updated each time when each setting is input as described above and determines that the image data set is the desired data set, the user presses a camera simulation execution button on the GUI. A flow after the camera simulation execution button is pressed will be described later with reference to FIG. 6.

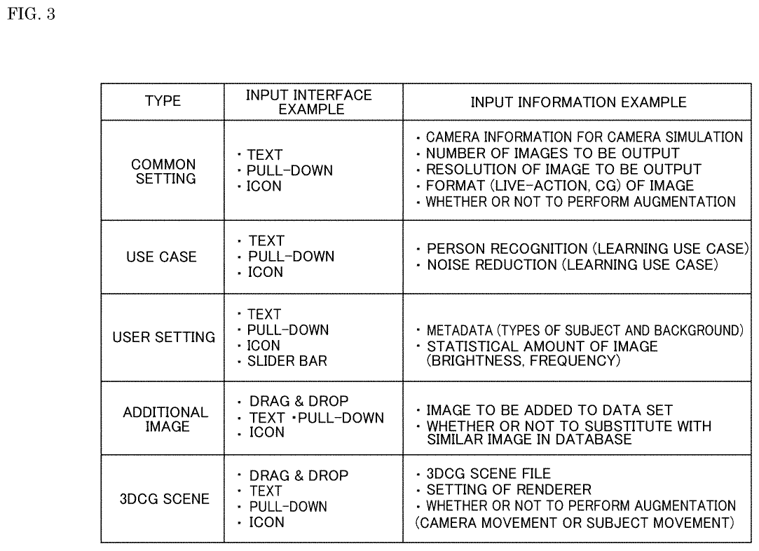

FIG. 3 is a diagram illustrating an example of an input interface of each setting and an example of information input in each setting.

As illustrated in FIG. 3, the common setting is input using an input interface such as a text box, a pull-down menu, or an icon. When the common setting is input, information regarding a camera for camera simulation (camera information), the number of learning images to be output, a resolution of the learning image to be output, a format of an image to be output, which one of a live-action image and a CG image is desired as the learning image, whether or not to perform augmentation, or the like are input.

The use case is input using the input interface such as the text box, the pull-down menu, or the icon. In the input of the use case, for example, a type of the use case such as person recognition or noise reduction is input.

The user setting is input using the input interface such as the text box, the pull-down menu, the icon, or a slider bar. In the input of the user setting, a condition desired by the user for the learning image, such as metadata such as a type of a subject or a background, a statistical amount of an image such as brightness or a frequency is input.

The additional image is input using drag and drop or the input interface such as the text box, the pull-down menu, or the icon. In the input of the additional image, an option is input that indicates an image to be added to the data set and whether or not to substitute the additional image with the similar image in the database.

The input of 3DCG scene is input, using the drag and drop or the input interface such as the text box, the pull-down menu, or the icon. In the input of the 3DCG scene, the 3DCG scene file, setting of a renderer, whether or not to perform augmentation due to movement of a virtual camera or movement of the subject, or the like are input.

The details of the data set generation performed in step S5 in FIG. 2 will be described with reference to FIG. 4.

In the data set generation, as illustrated in FIG. 4, for example, any one of three pieces of processing in steps S31 to S33 is executed according to the type of the setting input via the GUI. In each of the three pieces of processing in steps S31 to S33, it is assumed that the common setting be input in common.

In a case where the use case and the common setting are input, in step S31, the data set generation device 1 selects, for example, the images suitable for the use case, from among the image group registered in the database, by the number input in the common setting, as the learning image. For example, the data set generation device 1 selects the image suitable for the use case, based on a table in which each image registered in the database, a score for the use case, the metadata, the statistical amount, or the like are registered. The score for the use case indicates a degree at which each image registered in the database is suitable as a learning image of AI used for a certain use case.

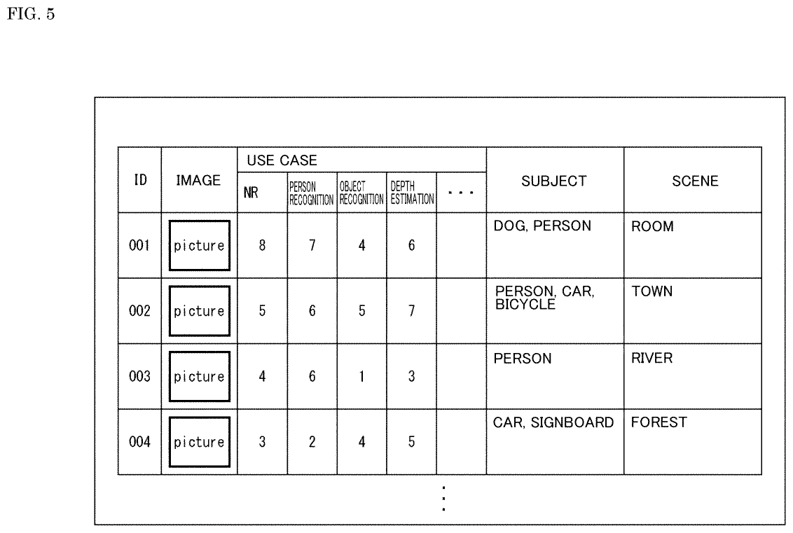

FIG. 5 is a diagram illustrating an example of the table used to select the image suitable for the use case.

In the example in FIG. 5, in the table, an ID, an image file, the score for the use case, the subject, and the background (scene) of each image registered in the database are registered.

In the table, expected use cases are listed, and a score for each use case is registered in advance. In the example in FIG. 4, as the use case, noise reduction (NR), person recognition, object recognition, and depth estimation are exemplified. As the score for the use case is higher, the image is more suitable for as the learning image of the AI used for the use case.

In the table in FIG. 5, an image to which an ID of 001 is allocated is assigned with 8 as a score for the NR, 7 as a score for the person recognition, 4 as a score for the object recognition, and 6 as a score for the depth estimation. In the table, imaging a dog and a person in the image to which the ID of 001 is allocated as subjects is registered, and imaging a room as the background is registered.

In the table in FIG. 5, an image to which an ID of 002 is allocated is assigned with 5 as the score for the NR, 6 as the score for the person recognition, 5 as the score for the object recognition, and 7 as the score for the depth estimation. In the table, imaging a person, a car, and a bicycle in the image to which the ID of 002 is allocated as the subjects is registered, and imaging a town as the background is registered.

In the table in FIG. 5, an image to which an ID of 003 is allocated is assigned with 4 as the score for the NR, 6 as the score for the person recognition, 1 as the score for the object recognition, and 3 as the score for the depth estimation. In the table, imaging a person in the image to which the ID of 003 is allocated as the subject is registered, and imaging a river as the background is registered.

In the table in FIG. 5, an image to which an ID of 004 is allocated is assigned with 3 as the score for the NR, 2 as the score for the person recognition, 4 as the score for the object recognition, and 5 as the score for the depth estimation. In the table, imaging a car and a signboard in the image to which the ID of 004 is allocated as the subjects is registered, and imaging a forest as the background is registered.

For example, the data set generation device 1 selects, as the learning images, the images as many as those input in the common setting, in descending order of the score for the use case input via the GUI, from among the images registered in the database.

Returning to FIG. 4, in a case where the user setting and the common setting are input, in step S32, for example, the data set generation device 1 selects the learning image by referring to the metadata registered in the database. Specifically, the data set generation device 1 selects the images corresponding to a user's desire input in the user setting, as many as those input in the common setting, based on the table described above, from among the image group registered in the database, as the learning image.

In a case where the additional image and the common setting are input, in step S33, for example, the data set generation device 1 searches for the image similar to the additional image, from among the image group registered in the database and adds the searched image to the image data set. For example, in a case where the number of learning images included in the data set exceeds the number input in the common setting, by adding the image similar to the additional image, some images originally included in the data set are excluded from the data set, so that the number of learning images becomes the same as the number input in the common setting. For example, the image to be excluded from the data set may be determined on the basis of the score of each learning image for the use case, such that the images are excluded from the data set in ascending order of the score for the use case.

Next, a flow after the data set is generated will be described with reference to FIG. 6.

In step S41, the data set generation device 1 receives pressing of the camera simulation execution button via the GUI.

When the camera simulation execution button is pressed, the data set generation device 1 executes processing in steps S42 and S46 surrounded by a broken line.

In step S42, the data set generation device 1 executes camera simulation. In the camera simulation, process processing based on the camera information for the camera simulation is executed on the image, the additional image, and the rendering image included in the image data set, and a simulated image data set is generated.

The data set generation device 1 generates an image that reproduces an image captured by a camera indicated by the camera information, for example, by the process processing based on the camera information. Images included in the simulated image data set include the image, the additional image, and the rendering image included in the image data set, including noise or the like generated on the image by imaging performed by the camera to be reproduced. Note that the camera that is a reproduction target in the camera simulation is set as, for example, a camera that captures an image to be input to the AI generated by the learning device 2.

In order to accurately reproduce the image captured by the camera to be reproduced, it is desirable that the image, the additional image, and the rendering image included in the image data set to be process processing targets be ideal images. The ideal image is an image that does not include noise or the like.

In step S43, the data set generation device 1 stores the simulated image data set.

In step S44, the data set generation device 1 performs image analysis on the simulated image data set and acquires a statistical amount of the entire simulated image data set.

In step S45, the data set generation device 1 stores the statistical amount of the simulated image data set.

In step S46, the data set generation device 1 executes metadata processing on the additional image and the rendering image. Specifically, the data set generation device 1 performs object recognition or the like on the additional image and the rendering image and acquires metadata corresponding to each of the additional image and the rendering image.

In step S47, the data set generation device 1 stores the metadata set generated in the data set generation in step S5 and the metadata acquired in step S46 as a single metadata set.

In step S48, the data set generation device 1 displays an output data set on the GUI. The output data set includes the simulated image data set, the statistical amount of the simulated image data set, and the metadata set.

In step S49, the user views display of the output data set on the GUI and determines whether or not the output data set is a desired data set.

In a case where it is determined in step S49 that the output data set is not the desired data set, returning to step S1 in FIG. 2, the user further inputs or changes the setting using the GUI.

On the other hand, in a case where it is determined in step S49 that the output data set is the desired data set, in step S50, the user operates the learning device 2 to learn the AI. To learn the AI, the output data set output from the data set generation device 1 via the GUI is used.

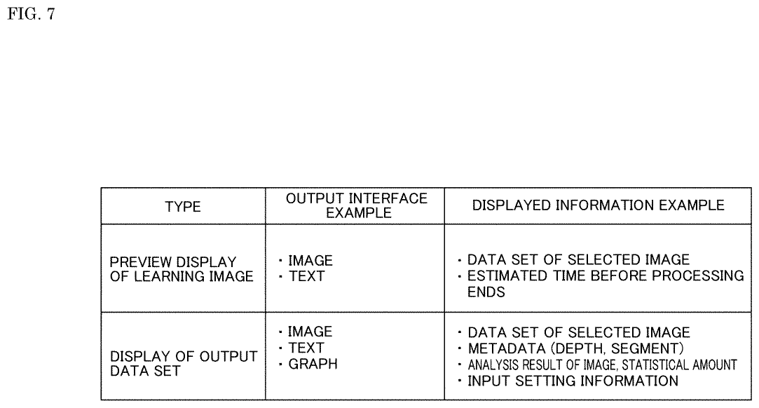

FIG. 7 is a diagram illustrating an example of an output interface of display on the GUI and an example of displayed information.

As illustrated in FIG. 7, the preview display of the learning image is performed using the output interface such as an image or a text. In the preview display of the learning image, a data set including an image selected as the learning image, an estimated time before the camera simulation processing ends, or the like are displayed.

The output data set is displayed using an output interface such as an image, a text, or a graph. In the display of the output data set, a data set including an image selected as the learning image (simulated image), metadata corresponding to each learning image, an analysis result of each learning image, the statistical amount of the entire image data set, and information regarding the input settings, or the like are displayed.

### <2. About GUI>

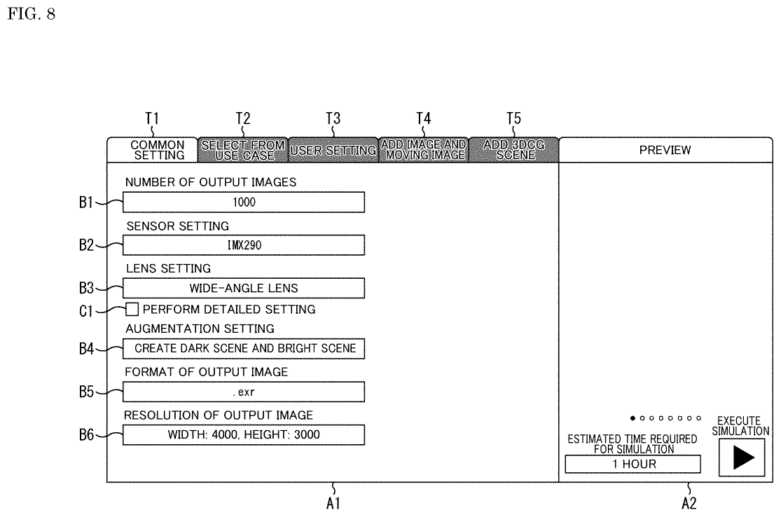

The GUI displayed by the data set generation device 1 will be described, with reference to FIGS. 8 to 17. In the data set generation device 1, the input GUI used to input the use case or the like by the user and the output GUI used to confirm the output data set by the user are displayed. For example, the input GUI is displayed before the camera simulation is executed, and the output GUI is displayed before the output data set is output to the learning device 2 and after the camera simulation is executed.

### About Input GUI

FIG. 8 is a diagram illustrating a first display example of the input GUI.

As illustrated in FIG. 8, the input GUI includes an input region A1 and a preview region A2. In the input region A1, a screen including input means for inputting various settings is displayed, and in the preview region A2, the preview display of the learning image is performed.

On an upper side of the input region A1, five tabs T1 to T5 are displayed. When each of the tabs T1 to T5 is selected, a screen used to input any one of the common setting, the use case, the user setting, the additional image, and the 3DCG scene is displayed in the input region A1. In FIG. 8, the tab T1 is indicated in white, which indicates that the tab T1 is selected from among the tabs T1 to T5. In this case, in the input region A1, a common setting input screen that is a screen including input means for inputting the common setting is displayed.

In an upper left portion of the common setting input screen, an input box B1 used to input the number of learning images to be output is displayed. In the example in FIG. 8, outputting 1000 learning images is input.

On a lower side of the input box B1, an input box B2 used to input information regarding an image sensor provided in the camera to be reproduced in the camera simulation is displayed. As the information regarding the image sensor, for example, a model of the image sensor and characteristics of the image sensor are input. The data set generation device 1 can simulate noise or the like generated when an image is acquired by the image sensor, based on the information regarding the image sensor. In the example in FIG. 8, the model “IMX290” is input.

On a lower side of the input box B2, an input box B3 used to input information regarding a lens provided in the camera to be reproduced in the camera simulation is displayed. As the information regarding the lens, for example, a kind (type) of the lens is input. In the example of FIG. 8, a kind of “wide-angle lens” is input.

On a lower side of the input box B3, a check box C1 used to select whether or not to input detailed setting is displayed. When the detailed setting is selected, for example, on the common setting input screen, input means for inputting data of point spread function (PSF) or distortion measured for the camera to be reproduced is displayed.

Note that the information regarding the image sensor, the information regarding the lens, and the detailed setting are included in the camera information for camera simulation. As the camera information, information regarding camera settings or imaging conditions may be input.

On a lower side of the check box C1, an input box B4 used to input setting of the augmentation is displayed. As the setting of the augmentation, what is changed by the augmentation, for example, a noise amount or brightness is changed, is input. In the example in FIG. 8, creation of a dark image and a bright image by changing the brightness of the image is input. In a case where it is not necessary to perform the augmentation, the user can input, for example, that the setting of the augmentation is not input, or the augmentation is not performed, as the setting.

On a lower side of the input box B4, an input box B5 used to input a format (data format) of the learning image to be output is displayed. In the example in FIG. 8, a format “.exr” is input.

On a lower side of the input box B5, an input box B6 used to input a resolution of the learning image to be output is displayed. In the example in FIG. 8, output of a learning image having a width of 4000 pixels and a height of 3000 pixels is input.

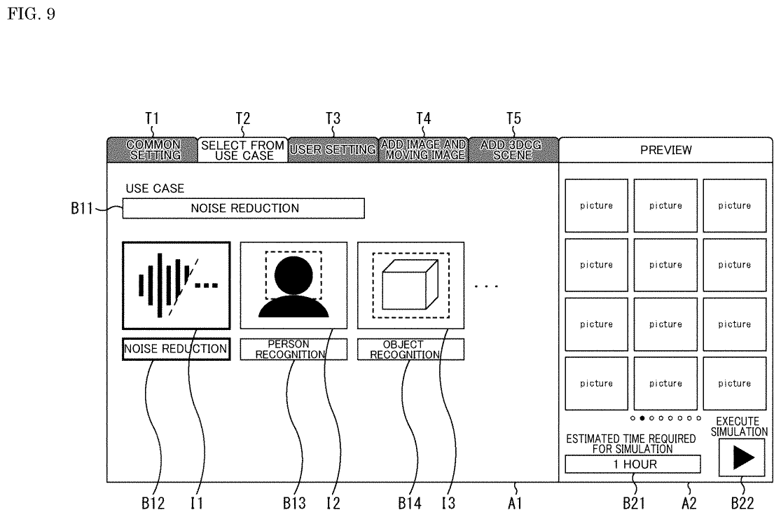

FIG. 9 is a diagram illustrating a second display example of the input GUI.

In FIG. 9, the tab T2 is indicated in white, which indicates that the tab T2 is selected from among the tabs T1 to T5. In this case, in the input region A1, a use case input screen that is a screen including input means for inputting the use case is displayed.

In an upper left portion of the use case input screen, an input box B11 used to input the use case is displayed. In the example in FIG. 9, it is input that the use case of the AI is noise reduction.

On a lower side of the input box B11, a list of expected use cases is displayed as icons and buttons. In the example in FIG. 9, an icon I1 and a button B12 indicating the noise reduction, an icon I2 and a button B13 indicating the person recognition, and an icon I3 and a button B14 indicating the object recognition are displayed. Since the noise reduction is input as the use case in the input box B11, the icon I1 and the button B12 indicating the noise reduction are highlighted and displayed as compared with the other icons and buttons, to be surrounded and indicated by thick lines in FIG. 9.

The user can input a purpose (use case) of using the AI, by performing the input using the input box B11 or pressing the icon or the box. In a case where the use case is input using the input box B11, the input use case is reflected on the display of the icon and the button, and in a case where the use case is input using the icon or the button, the input use case is reflected of the display of the input box B11.

When the common setting and the use case are input, as illustrated on the right side in FIG. 9, in the preview region A2, preview display is performed for displaying a list of the learning images selected on the basis of the common setting and the use case. In the preview display, a thumbnail image indicating each learning image is arranged and displayed. In the example in FIG. 9, 4×3 (vertical×horizontal) thumbnail images are arranged and displayed in a tile-like shape.

In a case where the number of selected learning images is more than 12, the data set generation device 1 switches a thumbnail image displayed in the preview region A2, by receiving a predetermined operation by the user. In the example of the preview region A2 in FIG. 9, information regarding the number of selected learning images is displayed as white and black circles illustrated on a lower side of the thumbnail image.

In a lower left portion of the preview region A2, an input box B21 used to present an estimated time before the processing of the camera simulation ends is displayed. In the example in FIG. 9, one hour is displayed as the estimated time before the processing of the camera simulation ends.

In a lower right portion of the preview region A2, a camera simulation execution button B22 is displayed.

Note that, in the preview region A2, preview display of the simulated image may be performed. In the preview display of the simulated image, for example, one predetermined image on which the process processing based on the input camera information is executed is displayed on a right side of the thumbnail image of the learning image. The predetermined one image may be one image of the learning images included in the image data set, or may be one image determined in advance.

The user can view the preview display of the simulated image and confirm whether the process processing executed on the image in the camera simulation is desired process processing.

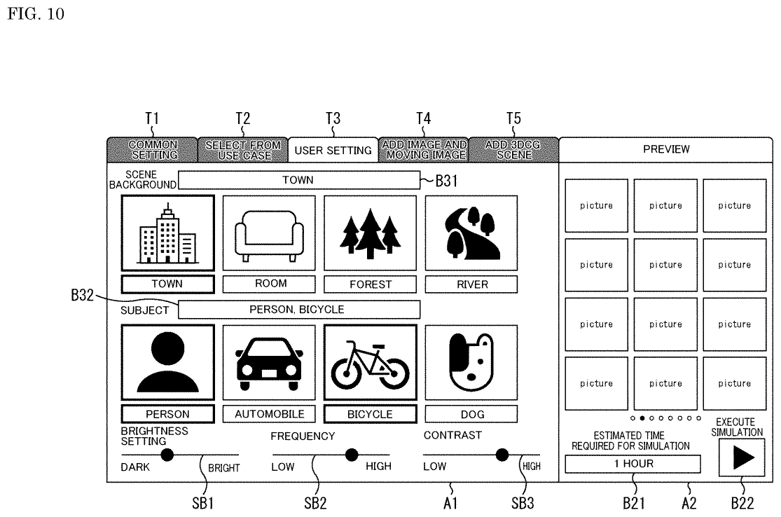

FIG. 10 is a diagram illustrating a third display example of the input GUI.

In FIG. 10, the tab T3 is indicated in white, which indicates that the tab T3 is selected from among the tabs T1 to T5. In this case, in the input region A1, a user setting input screen that is a screen including input means for inputting the user setting is displayed.

In an upper portion of the user setting input screen, an input box B31 used to input a type of the background of the learning image is displayed. In the example in FIG. 10, outputting of a learning image in which a town is imaged as the background is input.

On a lower side of the input box B31, a list of expected backgrounds is displayed as icons and buttons. In the example in FIG. 10, icons and buttons respectively indicating a town, a room, a forest, and a river are displayed. Since the town is input as the background in the input box B31, the icon and the button indicating the town are highlighted and displayed as compared with the other icons and buttons, to be surrounded and indicated by thick lines in FIG. 10.

The user can input a type of a background desired as the background of the learning image, by performing the input using the input box B31 or pressing the icon or the button. In a case where the type of the background is input using the input box B31, the input type of the background is reflected on the display of the icon and the button, and in a case where the type of the background is input using the icon or the button, the input type of the background is reflected on the display of the input box B31.

On a lower side of the button indicating the type of the background, an input box B32 used to input a type of a subject of the learning image is displayed. In the example in FIG. 10, outputting a learning image in which a person and a bicycle are imaged as the subjects is input.

On a lower side of the input box B32, a list of expected subjects is displayed as icons and buttons. In the example in FIG. 10, icons and buttons indicating a person, an automobile, a bicycle, and a dog are displayed. Since the person and the bicycle are input as the subjects in the input box B32, the icons and the buttons respectively indicating the person and the bicycle are highlighted and displayed as compared with the other icons and buttons, to be surrounded and indicated by thick lines in FIG. 10.

The user can input a type of the subject desired as the subject of the learning image, by performing the input using the input box B32 or pressing the icon or the button. In a case where the type of the subject is input using the input box B32, the input type of the subject is reflected on the display of the icon and the button, and in a case where the type of the subject is input using the icon or the button, the input type of the subject is reflected on the display of the input box B32.

In a lower left portion of the user setting input screen, a slider bar SB1 used to input brightness of an image is displayed. The user can adjust the brightness of the learning image, by moving a slider on the slider bar SB1. In the example in FIG. 10, in a case where the slider of the slider bar SB1 is moved by the user to the left side, the data set generation device 1 selects an image darker than an image originally selected as the learning image, as the learning image, for example. The data set generation device 1 can change the brightness of the learning image, without changing the learning image, according to an operation by the user.

At a lower center of the user setting input screen, a slider bar SB2 used to input a frequency of an image (spatial frequency) is displayed. The user can adjust a frequency of the learning image, by moving a slider on the slider bar SB2. In the example in FIG. 10, in a case where the slider on the slider bar SB2 is moved by the user to the left side, the data set generation device 1 selects, for example, an image in which the subject has a flatter pattern (image of which color does not change very much or the like) than the image originally selected as the learning image, as the learning image. The data set generation device 1 can change the frequency of the learning image, without changing the learning image, according to the operation by the user.

In a lower right portion of the user setting input screen, a slider bar SB3 used to input a contrast of an image is displayed. The user can adjust the contrast of the learning image, by moving a slider on the slider bar SB3. In the example in FIG. 10, in a case where the slider on the slider bar SB3 is moved by the user to the left side, the data set generation device 1 selects, for example, an image having a lower contrast than the image originally selected as the learning image, as the learning image. The data set generation device 1 can change the contrast of the learning image, without changing the learning image, according to the operation by the user.

When the common setting, the use case, and the user setting are input, in the preview region A2, a list of the learning images selected on the basis of the common setting, the use case, and the user setting is displayed.

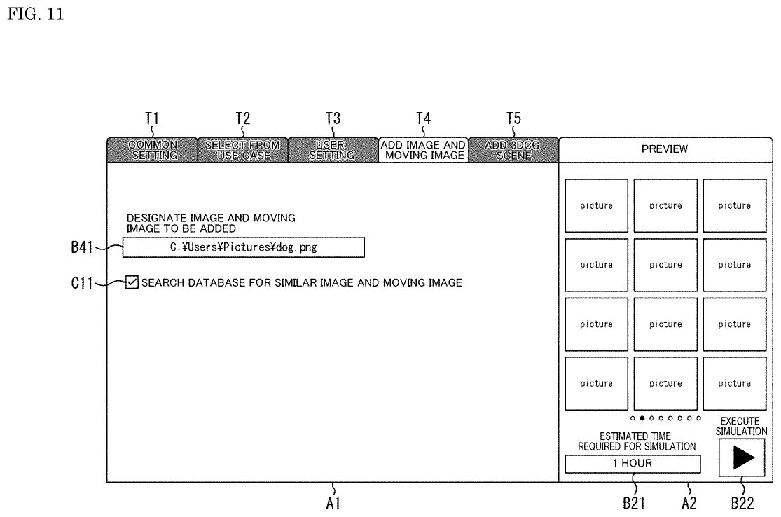

FIG. 11 is a diagram illustrating a fourth display example of the input GUI.

In FIG. 11, the tab T4 is indicated in white, which indicates that the tab T4 is selected from among the tabs T1 to T5. In this case, in the input region A1, an additional image input screen that is a screen including input means for inputting the additional image is displayed.

In an upper left portion of the additional image input screen, an input box B41 used to input the additional image is displayed. In the input box B41, for example, a path of the additional image is input. In the example in FIG. 11, a path “C:¥Users¥Pictures¥dog.png” is input. Note that, similarly to the image registered in the database, the additional image may include a still image or a moving image.

On a lower side of the input box B41, a check box C11 used to select whether or not to search the database for the similar image of the additional image is displayed. When it is selected to search for the similar image, the data set generation device 1 searches the image group registered in the database for the similar image of the additional image and adds the similar image to the image data set.

When the additional image is input, in the preview region A2, a list of the learning images including the additional image or the similar image of the additional image is displayed.

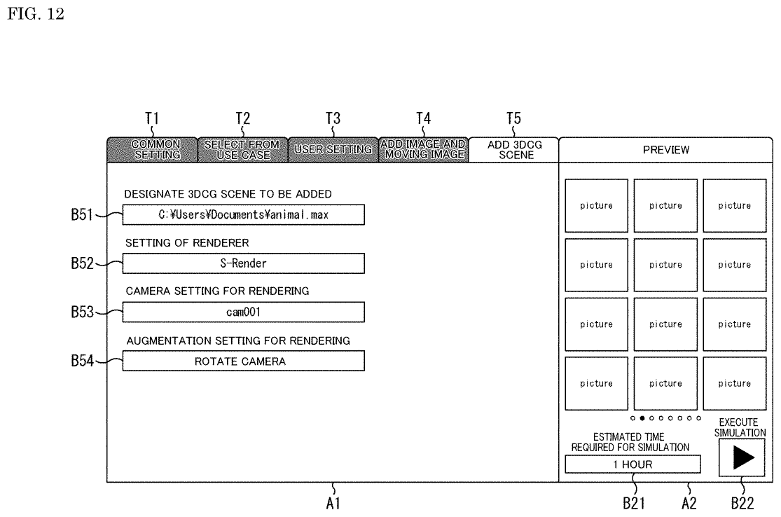

FIG. 12 is a diagram illustrating a fifth display example of the input GUI.

In FIG. 12, the tab T5 is indicated in white, which indicates that the tab T5 is selected from among the tabs T1 to T5. In this case, in the input region A1, a 3DCG scene input screen that is a screen including input means for inputting the 3DCG scene is displayed.

In an upper left portion of the 3DCG scene input screen, an input box B51 used to input the 3DCG scene file is displayed. In the input box B51, for example, a path of the 3DCG scene file is input. In the example in FIG. 12, a path “C:¥Users¥Documents¥animal.max” is input.

On a lower side of the input box B51, an input box B52 used to input the renderer used for rendering of the 3DCG scene is displayed. In the example in FIG. 12, a renderer “S-Render” is input.

On a lower side of the input box B52, an input box B53 used to input a virtual camera to be a viewpoint of the rendering image, among the virtual cameras arranged in the virtual space is displayed. In the example in FIG. 12, generation of a rendering image viewed from a viewpoint of “cam001” is input.

On a lower side of the input box B53, an input box B54 used to input setting of the augmentation is displayed. As the setting of the augmentation, what is changed by the augmentation, for example, rotating the virtual camera, is input. In the example in FIG. 12, creation of a plurality of images by rotating the (virtual) camera at the time of rendering is input. In a case where it is not necessary to perform the augmentation, the user can input, for example, that the setting of the augmentation is not input, or the augmentation is not performed.

When the 3DCG scene is input, in the preview region A2, a list of learning images including the rendering image generated on the basis of the 3DCG scene file is displayed. Note that, similarly to the image registered in the database, the rendering image may include a still image or a moving image.

### About Output GUI

The output GUI is displayed, for example, when the camera simulation execution button B22 is pressed on the input GUI and the processing of the camera simulation ends.

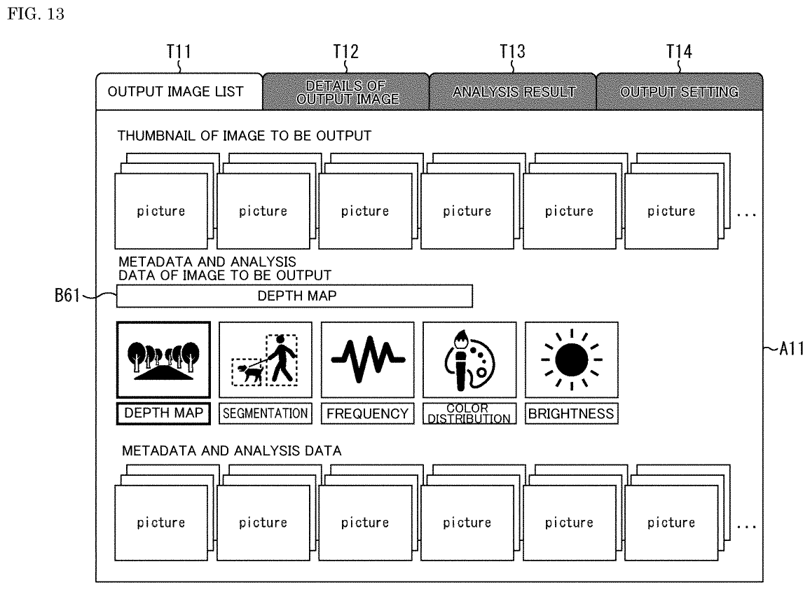

FIG. 13 is a diagram illustrating a first display example of the output GUI.

As illustrated in FIG. 13, the output GUI includes an output data set display region A11. In the output data set display region A11, the output data set is displayed.

On an upper side of the output data set display region A11, four tabs T11 to T14 are displayed. When each of the tabs T11 to T14 is selected, a screen used to confirm any one of a list of the simulated learning images, details of the simulated learning image, a statistical amount (analysis result) of the simulated image data set, and output setting is displayed, in the output data set display region A11. In FIG. 13, the tab T11 is indicated in white, which indicates that the tab T11 is selected from among the tabs T11 to T14. In this case, in the output data set display region A11, the list of the simulated learning images is displayed.

In an upper portion of the output data set display region A11, the list of the simulated learning images is displayed. Specifically, thumbnail images indicating the simulated learning images are arranged and displayed. In the example in FIG. 13, combinations of three thumbnail images arranged in a depth direction are arranged and displayed in a horizontal direction. For example, a plurality of images such as images having the same type of the subject or images of which pieces of metadata or statistical amounts (brightness, frequency, or the like) are close to each other are arranged and displayed in the depth direction.

On a lower side of the thumbnail image indicating the learning image, an input box B61 used to input a type of the metadata or a type of the statistical amount (analysis data) of the learning image that the user wants to confirm is displayed. In the example in FIG. 13, it is input that the user wants to confirm the depth map.

On a lower side of the input box B61, a list of metadata and statistical amounts that can be displayed is displayed as the icons and the buttons. In the example in FIG. 13, icons and buttons indicating the depth map and the segmentation result as the metadata and a frequency, a color distribution, and a brightness distribution as the statistical amounts are displayed. Since the depth map is input in the input box B61, the icon and the button indicating the depth map are highlighted and displayed as compared with the other icons and buttons, to be surrounded and indicated by thick lines in FIG. 13.

The user can input the type of the metadata or the type of the statistical amount to be confirmed, by performing the input using the input box B61 or pressing the icon or the button. In a case where the type of the metadata or the statistical amount is input using the input box B61, the input type of the metadata or the statistical amount is reflected on the display of the icon or the button. In a case where the type of the metadata or the statistical amount is input using the icon and the button, the input type of the metadata or the statistical amount is reflected on the display of the input box B61.

On a lower side of the buttons indicating the types of the metadata and the statistical amount, a list of the metadata and the statistical amounts of the type input using the input box B61 or the like is displayed. Specifically, images indicating the metadata and the statistical amount of the type input using the input box B61 or the like are arranged and displayed. A position of each of the images indicating the metadata and the statistical amount corresponds to a position of the simulated learning image displayed in the upper portion of the output data set display region A11. For example, an image indicating metadata corresponding to a learning image displayed on a first front side from the left in the upper portion of the output data set display region A11 is displayed on the first front side from the left in the lower portion of the output data set display region A11.

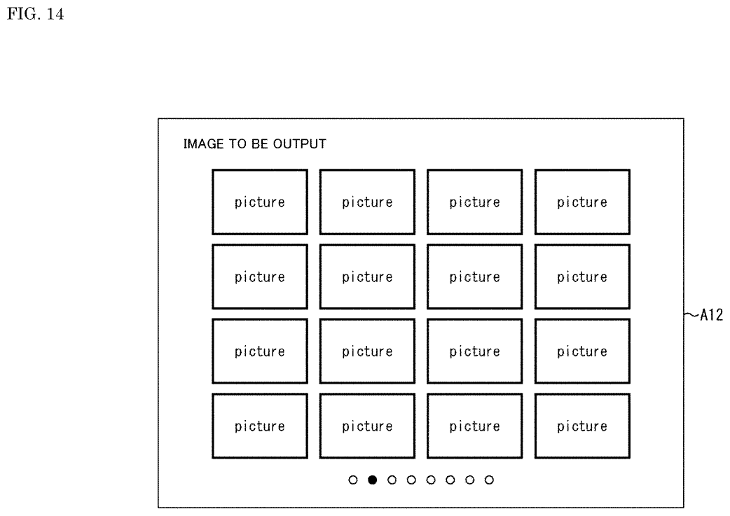

When a thumbnail image displayed in the upper portion of the output data set display region A11 is pressed by the user, a learning image list screen A12 illustrated in FIG. 14 is popped up, for example. In the learning image list screen A12, a list of the simulated learning images is displayed. Specifically, the thumbnail images indicating the simulated learning images are arranged and displayed in a tile-like shape. In the example in FIG. 14, 4×4 (vertical×horizontal) thumbnail images are arranged and displayed.

In a case where the number of simulated learning images is more than 16, the data set generation device 1 switches a thumbnail image displayed in the learning image list screen A12, by receiving a predetermined operation by the user. In the example of the learning image list screen A12 in FIG. 14, information regarding the number of simulated learning images is displayed as white and black circles indicated on the lower side of the thumbnail image.

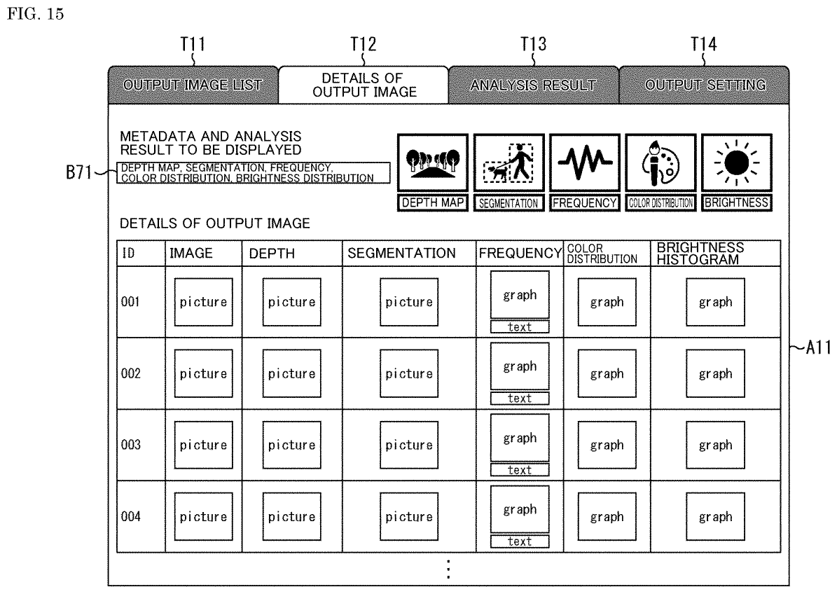

FIG. 15 is a diagram illustrating a second display example of the output GUI.

In FIG. 15, the tab T12 is indicated in white, which indicates that the tab T12 is selected from among the tabs T11 to T14. In this case, in the output data set display region A11, details of the simulated learning image is displayed.

On an upper left of the output data set display region A11, an input box B71 used to input the type of the metadata or the type of the statistical amount that the user wants to confirm is displayed. In the example in FIG. 15, it is input that the user wants to confirm the depth map, the segmentation, the frequency, the color distribution, and the brightness distribution.

On a right side of the input box B71, a list of metadata and statistical amounts that can be displayed is displayed as icons and buttons. In the example in FIG. 15, icons and buttons indicating the depth map, the segmentation, the frequency, the color distribution, and the brightness distribution are displayed. Since the depth map, the segmentation, the frequency, the color distribution, and the brightness distribution are input using the input box B71, the icons and the buttons indicating the depth map, the segmentation, the frequency, the color distribution, and the brightness distribution are highlighted and displayed to be surrounded and indicated by thick lines in FIG. 15.

The user can input the type of the metadata or the type of the statistical amount to be confirmed, by performing the input using the input box B71 or pressing the icon or the button. In a case where the type of the metadata or the statistical amount is input using the input box B71, the input type of the metadata or the statistical amount is reflected on the display of the icon or the button. In a case where the type of the metadata or the statistical amount is input using the icon and the button, the input type of the metadata or the statistical amount is reflected on the display of the input box B71.

On a lower side of the input box B71, a table is displayed in which the image indicating the metadata of the type input using the input box B71 or the like and a graph indicating the statistical amount are registered in association with the learning image. In the example of the table in FIG. 15, an ID of the learning image, a thumbnail image of the learning image, the depth map, an image indicating the segmentation result, a graph indicating the frequency, a graph indicating the color distribution, and a histogram of the brightness are displayed as a list. Note that, the ID of the learning image is not the ID allocated to each image in the database, and is an ID that is newly allocated to the image selected as the learning image.

Note that, in the table, the learning image can be sorted or searched, based on the ID or the like.

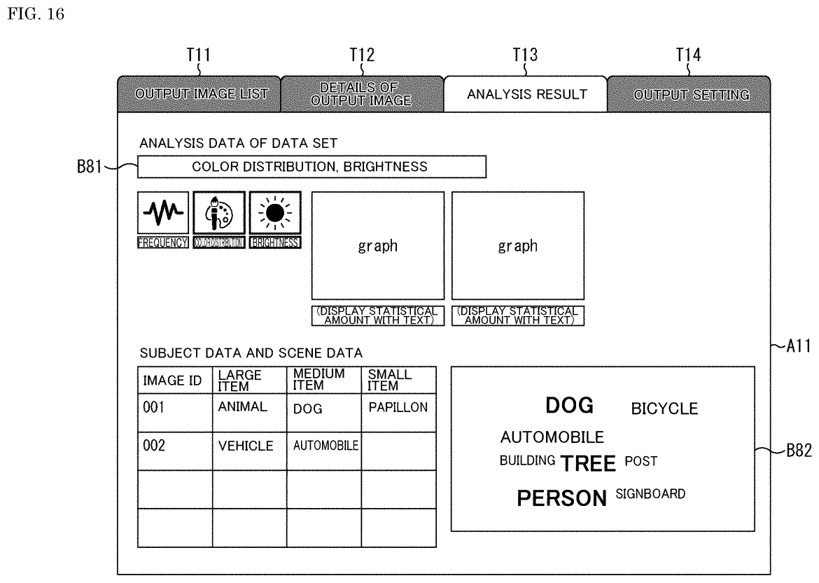

FIG. 16 is a diagram illustrating a third display example of the output GUI.

In FIG. 16, the tab T13 is indicated in white, which indicates that the tab T13 is selected from among the tabs T11 to T14. In this case, in the output data set display region A11, a statistical amount (analysis data) of the entire simulated image data set is displayed.

In an upper left portion of the output data set display region A11, an input box B81 used to input a type of the statistical amount of the entire image data set that the user wants to confirm is displayed. In the example in FIG. 16, it is input that the user wants to confirm the color distribution and the brightness distribution.

On a lower left side of the input box B81, a list of the statistical amounts that can be displayed is displayed as icons and buttons. In the example in FIG. 16, icons and buttons indicating the frequency, the color distribution, and the brightness distribution are displayed. Since the color distribution and the brightness distribution are input in the input box B81, the icons and the buttons indicating the color distribution and the brightness distribution are highlighted and displayed as compared with the other icons and buttons, to be surrounded and indicated by thick lines in FIG. 16.

The user can input the type of the statistical amount to be confirmed, by performing the input using the input box B81 or pressing the icon or the button. In a case where the type of the statistical amount is input using the input box B81, the input type of the statistical amount is reflected on the display of the icon and the button, and in a case where the type of the statistical amount is input using the icon or the button, the input type of the statistical amount is reflected on the display of the input box B81.

On a lower right side of the input box B81, a graph indicating the statistical amount of the type input using the input box B81 or the like is displayed. In the example in FIG. 16, a graph indicating the color distribution of the plurality of learning images included in the simulated image data set and a graph indicating the brightness distribution of the plurality of learning images are displayed.

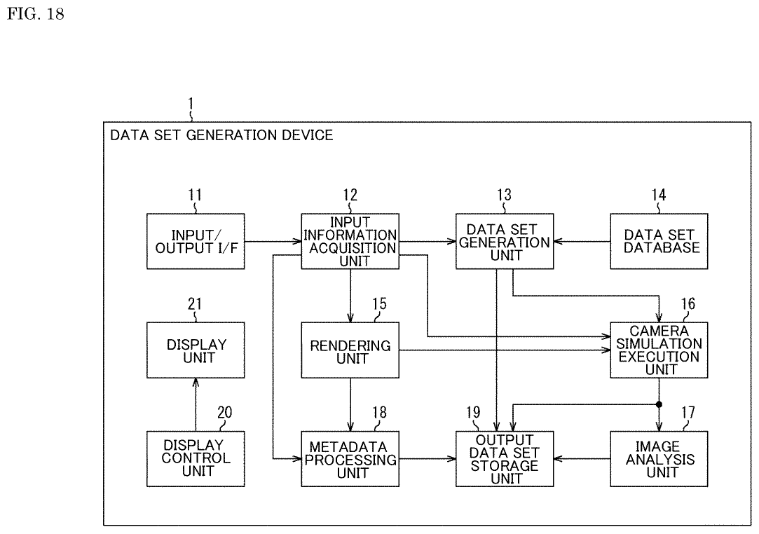

In a lower left portion of the output data set display region A11, a table is displayed that indicates a type of the subject or the background (scene) of each learning image. In the example of the table in FIG. 18, the type of the subject of each learning image is indicated by three granularities including a large item, a middle item, and a small item. For example, a subject of a learning image to which an ID of 001 is allocated is set as an animal in the large item, a dog in the middle item, and a papillon in the small item. A subject of a learning image to which an ID of 002 is allocated is set as a vehicle in the large item and an automobile in the middle item.

Note that, in the table, the learning image can be sorted or searched, based on the ID or the like.

In a lower right portion of the output data set display region A11, a box B82 visually indicating a distribution of the types of the subjects and the backgrounds in the image data set is displayed. In the box B82, a size of characters indicating the subject is changed and displayed, for example, according to the number of learning images in which the same subject is imaged. In the example of the box B82 in FIG. 18, as the number of learning images in which the same subject is imaged is larger, the size of the characters indicating the subject is displayed larger.

The user can press any one of the large item, the middle item, and the small item, in the table in the lower left portion of the output data set display region A11. In a case where a portion of the large item in the table is pressed, the data set generation device 1 performs the display in the box B82 according to the number of learning images in which animals, vehicles, and the like are imaged, and in a case where a portion of the middle item of the table is pressed, the data set generation device 1 performs display in the box B82 according to the number of learning images in which dogs, automobiles, and the like are imaged. In this way, the user can designate the granularity of the type of the subject displayed in the box B82, by pressing any one of the large item, the middle item, and the small item in the table.

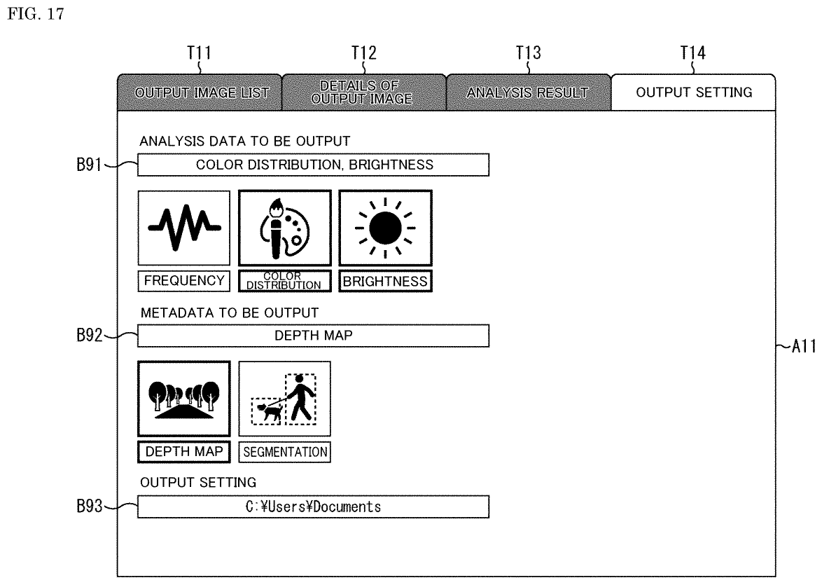

By viewing each display on the output GUI described with reference to FIGS. 13 to 16, the user can confirm whether or not the output data set is a desired data set. In a case where it is determined that the output data set is the desired data set, the user inputs output setting using the output GUI to be described with reference to FIG. 17.

FIG. 17 is a diagram illustrating a fourth display example of the output GUI.

In FIG. 17, the tab T14 is indicated in white, which indicates that the tab T14 is selected from among the tabs T11 to T14. In this case, in the output data set display region A11, input means used to input the output setting is displayed.

In an upper left portion of the output data set display region A11, an input box B91 used to input a type of the statistical amount (analysis data) that the user wants to include in the output data set is displayed. In the example in FIG. 17, outputting an output data set including the color distribution and the brightness distribution is input.

On a lower left side of the input box B91, a list of the statistical amounts that can be output is displayed as icons and buttons. In the example in FIG. 17, icons and buttons indicating the frequency, the color distribution, and the brightness distribution are displayed. Since the color distribution and the brightness distribution are input in the input box B91, the icons and the buttons indicating the color distribution and the brightness distribution are highlighted and displayed as compared with the other icons and buttons, to be surrounded and indicated by thick lines in FIG. 17.

The user can input the output type of the statistical amount, by performing the input using the input box B91 or pressing the icon or the button. In a case where the type of the statistical amount is input using the input box B91, the input type of the statistical amount is reflected on the display of the icon and the button, and in a case where the type of the statistical amount is input using the icon or the button, the input type of the statistical amount is reflected on the display of the input box B91.

Note that the output statistical amount may be the statistical amount of each learning image or the statistical amount of the entire image data set.

On a lower side of the button indicating the type of the statistical amount, an input box B92 used to input a type of the metadata that the user wants to include in the output data set is displayed. In the example in FIG. 17, outputting the depth map as the metadata set is input.

On a lower left side of the input box B92, a list of the metadata that can be output is displayed as icons and buttons. In the example in FIG. 17, icons and buttons indicating the depth map and the segmentation result are displayed. Since the depth map is input in the input box B92, the icon and the button indicating the depth map are highlighted and displayed as compared with the other icons and buttons, to be surrounded and indicated by thick lines in FIG. 17.

The user can input the output type of the metadata, by performing the input using the input box B92 or pressing the icon or the button. In a case where the type of the metadata is input using the input box B92, the input type of the metadata is reflected on the display of the icon and the button, and in a case where the type of the metadata is input using the icon or the button, the input type of the metadata is reflected on the display of the input box B92.

On a lower side of the button indicating the type of the metadata, an input box B93 used to input a path of a folder to which the output data set is output is displayed. In the example in FIG. 17, a path “C:¥Users¥Documents” is input.

After the output setting is input using the output GUI described with reference to FIG. 17, for example, in a case where a predetermined operation is received, the data set generation device 1 outputs the output data set.

Note that, in the input GUI and the output GUI as described above, the input box is implemented by a pull-down menu from which a desired menu can be selected, a text box to which a text can be input, or a combo box from which a desired menu can be selected or to which a text can be input, or the like.

As described above, the user can acquire the learning image suitable for learning the AI used for the use case, only by inputting the use case of the AI or the like, using the input GUI and the output GUI displayed by the data set generation device 1. The user can easily acquire the learning image suitable for learning the AI with a simple operation, without actually capturing an image or searching images published on the Internet for an image.

In the data set generation device 1, in a case where only an image that can be used without a license is registered in the database, the user can acquire a large number of learning images, without worrying about the license.

### <3. Configuration and Behavior of Data Set Generation Device>

### Configuration of Data Set Generation Device

FIG. 18 is a block diagram illustrating a configuration example of the data set generation device 1.

As illustrated in FIG. 18, the data set generation device 1 includes an input/output I/F 11, an input information acquisition unit 12, a data set generation unit 13, a data set database 14, a rendering unit 15, a camera simulation execution unit 16, an image analysis unit 17, a metadata processing unit 18, an output data set storage unit 19, a display control unit 20, and a display unit 21.

The input/output I/F 11 is an interface that inputs data into the data set generation device 1 and outputs data from the data set generation device 1. The data set generation device 1 may separately include an input I/F and an output I/F. The input/output I/F 11 detects an operation by the user on the input GUI or the output GUI and supplies information indicating operation content to the input information acquisition unit 12. Furthermore, the input/output I/F 11 acquires the output data set from the output data set storage unit 19, through a route (not illustrated) and outputs the output data set to the learning device 2.

The input information acquisition unit 12 acquires information regarding various settings input by the user, based on the information supplied from the input/output I/F 11. The input information acquisition unit 12 supplies information regarding the common setting, the use case, the user setting, and the additional image to the data set generation unit 13. The input information acquisition unit 12 supplies information regarding the 3DCG scene to the rendering unit 15. In a case where the similar image of the additional image is not searched, the input information acquisition unit 12 supplies the additional image to the camera simulation execution unit 16 and the metadata processing unit 18.

The data set generation unit 13 selects a learning image based on the information supplied from the input information acquisition unit 12, from among an image group registered in the data set database 14 and generates an image data set. The data set generation unit 13 functions as a selection unit that selects the learning image from among the image group registered in the data set database 14. Furthermore, the data set generation unit 13 acquires metadata corresponding to the selected learning image from the data set database 14 and generates a metadata set.

In a case where the similar image of the additional image is searched, the data set generation unit 13 searches for the similar image of the additional image, from the image group registered in the data set database 14 and adds the similar image to the image data set.

The data set generation unit 13 supplies the generated image data set to the camera simulation execution unit 16 and supplies the metadata set to the output data set storage unit 19.

In the data set database 14, an image generated using the CG, an image captured in a live-action manner, and metadata and a statistical amount corresponding to each image are registered in advance.

The rendering unit 15 performs rendering based on the information regarding the 3DCG scene supplied from the input information acquisition unit 12 and generates a rendering image. The rendering unit 15 supplies the rendering image to the camera simulation execution unit 16 and the metadata processing unit 18.

The camera simulation execution unit 16 executes the camera simulation on the additional image supplied from the input information acquisition unit 12, each learning image included in the image data set supplied from the data set generation unit 13, and the rendering image supplied from the rendering unit 15 and generates a simulated image data set. The camera simulation execution unit 16 functions as a process processing unit that executes the process processing based on the camera information on the additional image, the learning image included in the image data set, and the rendering image.

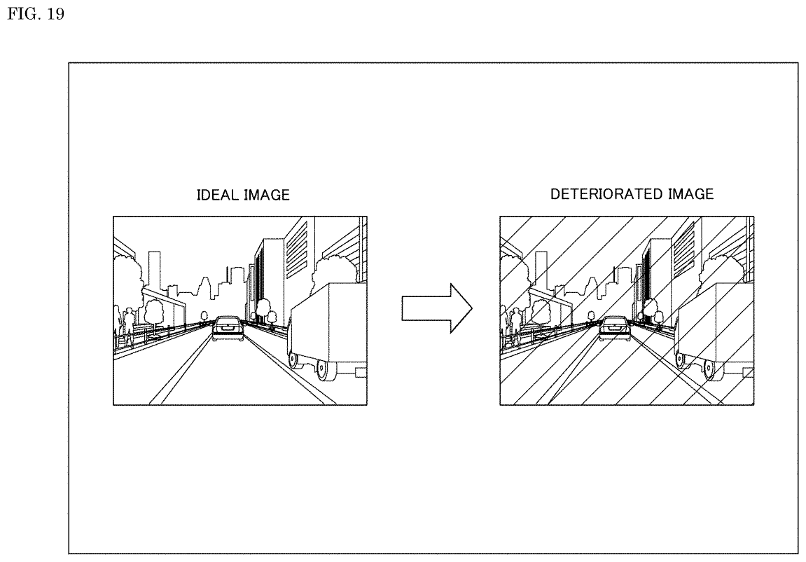

FIG. 19 is a diagram illustrating an example of the camera simulation.

As described above, it is desirable that the learning image, the additional image, and the rendering image included in the image data set be the ideal images. As illustrated in FIG. 19, the camera simulation execution unit 16 generates a deteriorated image by adding deterioration and noise generated on an image by imaging by the camera to be reproduced to the ideal image.

Specifically, for example, as indicated by the following formula (1), the camera simulation execution unit 16 generates a deteriorated image I′ by applying a model that convolves a deterioration factor K for an ideal image I and adds noise n.

$$\begin{matrix}[ Math . 1 ] & \\ {I}^{′} = I ⊗ K + n & ( 1 )\end{matrix}$$

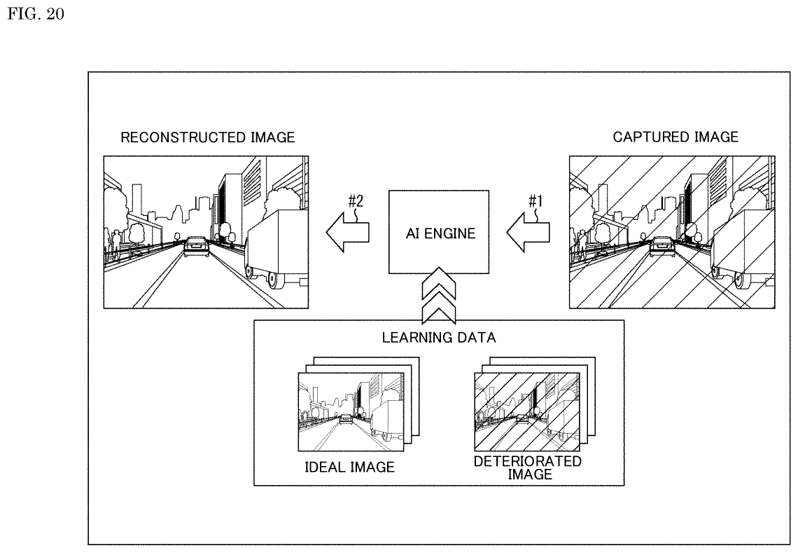

The AI estimates a deterioration factor and noise included in the deteriorated image, by learning using the deteriorated image and the ideal image as learning data. When a captured image including deterioration and noise same as the deterioration and the noise included in the deteriorated image used at the time of learning is input, to the AI engine including the AI, as indicated by an arrow #1 in FIG. 20, the AI engine outputs a reconstructed image with high image quality close to the ideal image, as indicated by an arrow #2.

In this way, it is desirable that the deterioration and the noise included in the deteriorated image used at the time of learning and the deterioration and the noise included in the captured image input into the AI engine at the time of inference be the same deterioration and noise. The camera simulation execution unit 16 can generate an image data set including a deteriorated image suitable for learning of the AI using the captured image captured by the camera to be reproduced as an input, by generating a deteriorated image including deterioration and noise generated on an image by imaging by the camera to be reproduced.

Note that the camera simulation execution unit 16 may generate the deteriorated image, by applying a model corresponding to a lens system of the camera to be reproduced and a model corresponding to a sensor system to the ideal image.

The model corresponding to the lens system may be a model that adds, to the ideal image, deterioration such as blur, distortion, shading, flare, ghost, or the like caused by a distortion of the lens, a transmittance, an optical filter, stray light, or the like. The model corresponding to the sensor system may be a model that adds deterioration caused by spectroscopy, color mixing, photoelectric conversion, or the like in the sensor to the ideal image. Furthermore, the model corresponding to the sensor system may be a model that adds optical shot noise, dark current shot noise, random shot noise, pattern noise, white spot noise, addition of pixel values, or the like in the sensor, to the ideal image.

The camera simulation execution unit 16 may generate the deteriorated image by performing application of a compression algorithm, conversion of a compression rate, compression at a variable bit rate, gradation thinning, or the like. In a case where the ideal image includes a moving image, the camera simulation execution unit 16 may generate the deteriorated image, by thinning frames.

The camera simulation execution unit 16 may generate the deteriorated image by applying a model that adds deterioration in consideration of a defect in the captured image by the sensor to the ideal image. The defect of the pixel may be a defect of at least any one of pixels that are not used for an image such as a pixel for image plane phase difference acquisition, a polarizing pixel, an IR acquisition pixel, a UV acquisition pixel, a pixel for distance measurement, or a temperature pixel, in addition to a defect in white, black, or a random value.

The camera simulation execution unit 16 may generate the deteriorated image by applying a model that considers other characteristics of the sensor. For example, the model may be a model that can acquire a deteriorated image in consideration of color filter characteristics of the sensor, a color filter array, temperature characteristics, a conversion efficiency, sensitivity (HDR rendering and gain characteristics), a reading order (rolling shutter distortion), or the like.

The camera simulation execution unit 16 may generate the deteriorated image by applying a model that can acquire an image in consideration of a camera corresponding to a multispectral image or a hyperspectral image.

The camera simulation execution unit 16 may generate the deteriorated image by performing conversion for reproducing an imaging condition. The imaging condition is, for example, a condition such as illumination, saturation, or exposure. The illumination indicates, for example, a type of a light source. For example, conversion for reproducing a light source such as sunlight, tunnel illumination, or street lamps may be performed. Furthermore, conversion for reproducing not only the type of the light source, but also a position of the light source or a direction in which the light source is directed may be performed. The deterioration due to the saturation is, for example, overexposure or the like and indicates deterioration exceeding a maximum value of a color of a pixel value due to reflection from surrounding pixels. The deterioration due to the exposure is deterioration caused under conditions such as a shutter speed or a diaphragm and indicates under-exposure, over-exposure, or the like. Conversion for reproduce focus of the lens may be performed.

Returning to FIG. 18, the camera simulation execution unit 16 supplies the simulated image data set to the image analysis unit 17 and the output data set storage unit 19.

The image analysis unit 17 analyzes the image of the learning image included in the simulated image data set supplied from the camera simulation execution unit 16 and acquires the statistical amount of the entire image data set. The image analysis unit 17 supplies the statistical amount of the entire image data set to the output data set storage unit 19.

The metadata processing unit 18 executes the metadata processing on the additional image supplied from the input information acquisition unit 12 and the rendering image supplied from the rendering unit 15 and acquires metadata corresponding to each of the additional image and the rendering image. The metadata processing unit 18 supplies the metadata corresponding to each of the additional image and the rendering image to the output data set storage unit 19.

The output data set storage unit 19 stores the metadata set supplied from the data set generation unit 13, the simulated image data set supplied from the camera simulation execution unit 16, and the statistical amount of the simulated image data set supplied from the image analysis unit 17, as the output data set. The output data set storage unit 19 adds the metadata corresponding to each of the additional image and the rendering image supplied from the metadata processing unit 18 to the metadata set and stores the metadata set.

The display control unit 20 acquires information from each component of the data set generation device 1, through a route (not illustrated), and generates the input GUI and the output GUI and displays the input GUI and the output GUI on the display unit 21.

The display unit 21 includes, for example, a display and displays the input GUI and the output GUI, according to control by the display control unit 20. Note that the display unit 21 may be provided in an external device.

### Behavior of Data Set Generation Device

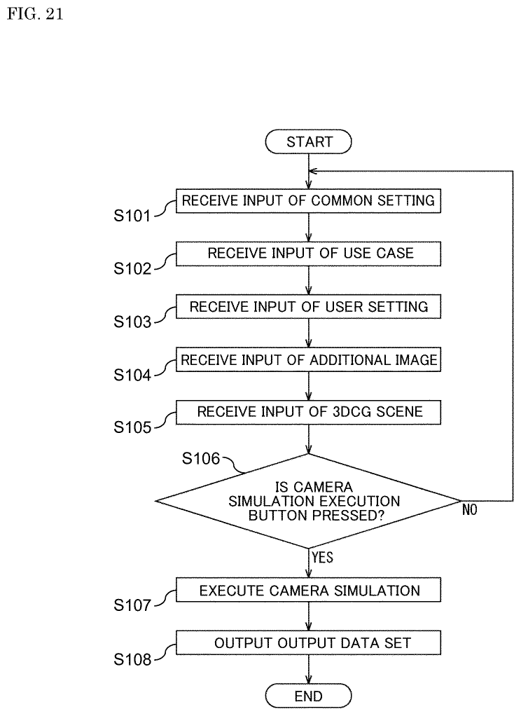

Here, processing executed by the data set generation device 1 having the above configuration will be described with reference to the flowchart in FIG. 21. The processing in FIG. 21 is started, for example, when the input GUI is displayed on the display unit 21.

In step S101, the input information acquisition unit 12 receives input of the common setting by the user.

In step S102, the input information acquisition unit 12 receives input of the use case by the user. Note that, in a case where a use case of the AI generated by learning using the output data set is not assumed by the user, the processing in step S102 is skipped.

In step S103, the input information acquisition unit 12 receives input of the user setting by the user. Note that, in a case where the user does not want to perform detailed setting, the processing in step S103 is skipped.

In step S104, the input information acquisition unit 12 receives input of the additional image by the user. Note that, in a case where there is no image that the user wants to add to the image data set, the processing in step S104 is skipped.

In step S105, the input information acquisition unit 12 receives input of the additional image by the user. Note that, in a case where the user does not want to add the rendering image to the image data set, the processing in step S105 is skipped.

In step S106, the input information acquisition unit 12 determines whether or not the camera simulation execution button is pressed.

In a case where it is determined in step S106 that the camera simulation execution button is not pressed, the processing returns to step S101, and subsequent processing is repeatedly executed.

When various settings are input in the processing in steps S101 to S105, an image data set according to the input settings is generated, and preview of the learning image is displayed on the input GUI. The user views the preview of the learning image and determines whether or not the image data set is a desired data set. In a case where it is determined whether or not the image data set is the desired data set, the camera simulation execution button is pressed by the user. In a case where it is determined in step S106 that the camera simulation execution button is pressed, the processing proceeds to step S107.

In step S107, the camera simulation execution unit 16 executes the camera simulation and generates a simulated learning data set.

In step S108, the input/output I/F 11 outputs an output data set including the simulated learning data set.

According to the above processing, the user can acquire the learning image suitable for learning the AI used for the use case, only by inputting the use case of the AI or the like, using the input GUI and the output GUI displayed by the data set generation device 1. The user can easily acquire the learning image suitable for learning the AI with a simple operation, without actually capturing an image or searching images published on the Internet for an image.

### <4. Modifications>

### About Input GUI

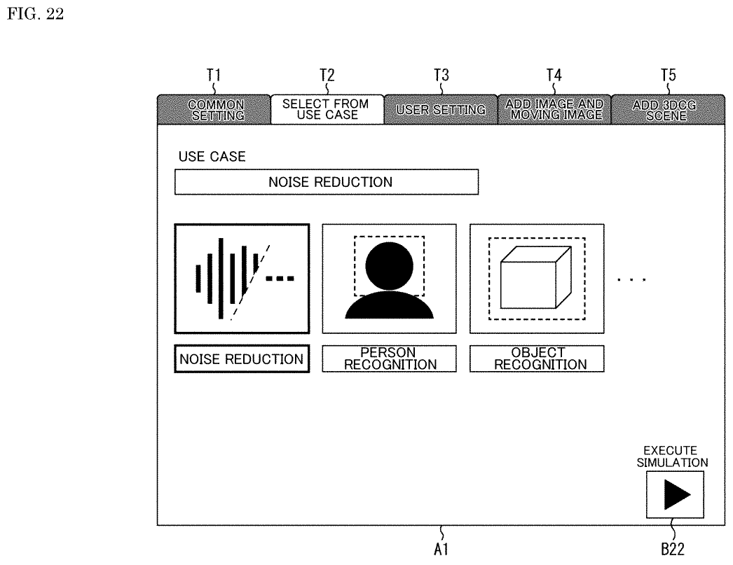

FIG. 22 is a diagram illustrating another display example of the input GUI.

As illustrated in FIG. 22, the input GUI may include the input region A1 excluding the preview region A2. In a case where the preview region A2 is not displayed as a part of the input GUI, the camera simulation execution button B22 is displayed, for example, in a lower right portion of the input region A1.

### About Computer

The series of processing described above can be executed by hardware or software. When the series of processing is executed by software, a program constituting the software is installed from a program recording medium on a computer embedded in dedicated hardware, a general-purpose personal computer, or the like.

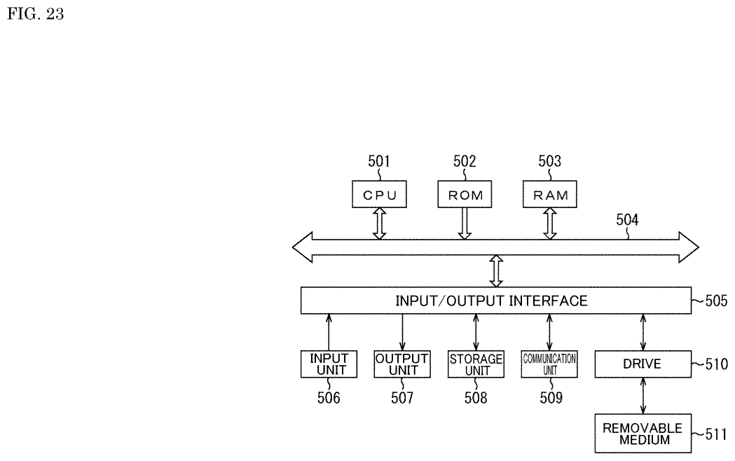

FIG. 23 is a block diagram illustrating a configuration example of hardware of a computer that executes the series of processing described above by a program.

A CPU 501, a ROM 502, and a RAM 503 are connected to each other with a bus 504.

An input/output interface 505 is further connected to the bus 504. An input unit 506 including a keyboard, a mouse, or the like and an output unit 507 including a display, a speaker, or the like are connected to the input/output interface 505. In addition, a storage unit 508 including a hard disk, a non-volatile memory, or the like, a communication unit 509 including a network interface or the like, and a drive 510 that drives a removable medium 511 are connected to the input/output interface 505.

In the computer configured as described above, for example, the CPU 501 performs the above-described series of processing by loading a program stored in the storage unit 508 into the RAM 503 via the input/output interface 505 and the bus 504 and executing the program.

The program executed by the CPU 501 is recorded on, for example, the removable medium 511 or is provided via wired or wireless transfer media such as a local area network, the Internet, or digital broadcasting and is installed in the storage unit 508.

The program executed by the computer may be a program that performs a plurality of steps of processing in time series in the order described herein or may be a program that performs a plurality of steps of processing in parallel or at a necessary timing such as when a call is made.

Meanwhile, as used herein, a system means a collection of a plurality of components (devices, modules (components), or the like), and all the constituent elements may be located or not located in the same casing. Thus, a plurality of devices stored in separate housings and connected via a network constitutes a system, and one device including a plurality of modules stored in a single housing is also a system.

The effects described herein are merely examples and are not intended to be limiting, and other effects may be obtained.

The embodiments of the present technique are not limited to the aforementioned embodiments, and various changes can be made without departing from the gist of the present technique.

For example, the present technique may be configured as cloud computing in which a plurality of devices shares and cooperatively processes one function via a network.

In addition, each step described in the above flowchart can be executed by one device or executed in a shared manner by a plurality of devices.

Furthermore, in a case where one step includes a plurality of processes, the plurality of processes included in the one step can be executed by one device or executed in a shared manner by a plurality of devices.

### Combination Example of Configurations

The present technique can be configured as follows.

(1)

An information processing device including:
a selection unit that selects a learning image used for learning of a learning model, according to a use case of the learning model using an image as an input, from among an image group held in advance.
   (2)

The information processing device according to (1), further including:
a display control unit that displays input means for a user to input the use case.
   (3)

The information processing device according to (2), in which
the input means to input the use case includes any one of a pull-down menu, a text box, a combo box, and an icon.
   (4)

The information processing device according to (2) or (3), further including:
a process processing unit that executes process processing based on information regarding a camera that captures an image to be input into the learning model, on the learning image.
   (5)

The information processing device according to (4), in which
the process processing unit executes the process processing by adding at least one of deterioration and noise generated in an image by imaging by the camera to the learning image.
   (6)

The information processing device according to (4) or (5), in which
the display control unit displays a list of images selected as the learning image, before the process processing is executed on the learning image.
   (7)

The information processing device according to any one of (4) to (6), in which
the display control unit displays an image on which the process processing is executed, before the process processing is executed on the learning image.
   (8)

The information processing device according to any one of (4) to (7), in which
the display control unit displays input means to input the information regarding the camera.
   (9)

The information processing device according to (8), in which
the information regarding the camera includes information regarding at least one of an image sensor and a lens provided in the camera.
   (10)

The information processing device according to (9), in which
the input means to input the information regarding the camera includes input means to input at least any one of a model or characteristics of the image sensor and a type of the lens.
   (11)

The information processing device according to any one of (1) to (10), in which
the selection unit selects the learning image, according to at least any one of, input by the user, a type of a subject, a type of a background, brightness, a frequency, and a contrast, from among the image group.
   (12)

The information processing device according to any one of (1) to (11), in which the selection unit adds an image selected from among the image group based on an image input by a user or the image input by the user, as the learning image.

(13)

The information processing device according to any one of (1) to (12), in which the selection unit adds an image generated on the basis of a CG model input by the user, as the learning image.

(14)

The information processing device according to any one of (1) to (13), in which the selection unit selects the learning image, based on a table in which a degree at which each image included in the image group is suitable for learning the learning model used for a predetermined use case is registered.

(15)

The information processing device according to any one of (1) to (14), further including:
an output unit that outputs the learning image to a learning device that learns the learning model; and
a display control unit that displays a list of the learning images, before the learning image is output.
   (16)

The information processing device according to (15), in which
the display control unit displays a list of at least one of metadata and a statistical amount corresponding to the learning image, before the learning image is output.
   (17)

The information processing device according to (15) or (16), in which
the display control unit displays at least any one of a statistical amount of a data set including a plurality of the learning images, information indicating a type of a subject or a background of each of the plurality of learning images, and information indicating a distribution of the type of the subject or the background in the data set, before the learning image is output.
   (18)

An information processing method performed by an information processing device, the method including:
selecting a learning image used for learning of a learning model, according to a use case of the learning model using an image as an input, from among an image group held in advance.
   (19)

A computer-readable recording medium recording a program for executing processing including:
selecting a learning image used for learning of a learning model, according to a use case of the learning model using an image as an input, from among an image group held in advance.

### REFERENCE SIGNS LIST

1 Data set generation device
2 Learning device
11 Input/output I/F
12 Input information acquisition unit
13 Data set generation device
14 Data set database
15 Rendering unit
16 Camera simulation execution unit
17 Image analysis unit
18 Metadata processing unit
19 Output data set storage unit
20 Display control unit
21 Display unit

What is claimed is:

1. An information processing device comprising:
a selection unit that selects a learning image used for learning of a learning model, according to a use case of the learning model using an image as an input, from among an image group held in advance.

2. The information processing device according to claim 1, further comprising:
a display control unit that displays input means for a user to input the use case.

3. The information processing device according to claim 2, wherein
the input means to input the use case includes any one of a pull-down menu, a text box, a combo box, and an icon.

4. The information processing device according to claim 2, further comprising:
a process processing unit that executes process processing based on information regarding a camera that captures an image to be input into the learning model, on the learning image.

5. The information processing device according to claim 4, wherein
the process processing unit executes the process processing by adding at least one of deterioration and noise generated in an image by imaging by the camera to the learning image.

6. The information processing device according to claim 4, wherein
the display control unit displays a list of images selected as the learning image, before the process processing is executed on the learning image.

7. The information processing device according to claim 4, wherein
the display control unit displays an image on which the process processing is executed, before the process processing is executed on the learning image.

8. The information processing device according to claim 4, wherein
the display control unit displays input means to input the information regarding the camera.

9. The information processing device according to claim 8, wherein
the information regarding the camera includes information regarding at least one of an image sensor and a lens provided in the camera.

10. The information processing device according to claim 9, wherein
the input means to input the information regarding the camera includes input means to input at least any one of a model or characteristics of the image sensor and a type of the lens.

11. The information processing device according to claim 1, wherein
the selection unit selects the learning image, according to at least any one of, input by the user, a type of a subject, a type of a background, brightness, a frequency, and a contrast, from among the image group.

12. The information processing device according to claim 1, wherein
the selection unit adds an image selected from among the image group based on an image input by a user or the image input by the user, as the learning image.

13. The information processing device according to claim 1, wherein
the selection unit adds an image generated on the basis of a CG model input by the user, as the learning image.

14. The information processing device according to claim 1, wherein
the selection unit selects the learning image, based on a table in which a degree at which each image included in the image group is suitable for learning the learning model used for a predetermined use case is registered.

15. The information processing device according to claim 1, further comprising:
an output unit that outputs the learning image to a learning device that learns the learning model; and
a display control unit that displays a list of the learning images, before the learning image is output.

16. The information processing device according to claim 15, wherein
the display control unit displays a list of at least one of metadata and a statistical amount corresponding to the learning image, before the learning image is output.

17. The information processing device according to claim 15, wherein
the display control unit displays at least any one of a statistical amount of a data set including a plurality of the learning images, information indicating a type of a subject or a background of each of the plurality of learning images, and information indicating a distribution of the type of the subject or the background in the data set, before the learning image is output.

18. An information processing method performed by an information processing device, the method comprising:
selecting a learning image used for learning of a learning model, according to a use case of the learning model using an image as an input, from among an image group held in advance.

19. A computer-readable recording medium recording a program for executing processing comprising:
selecting a learning image used for learning of a learning model, according to a use case of the learning model using an image as an input, from among an image group held in advance.
